(19) United States
(12) Patent Application Publication
(10) Pub. No.: US 2018/0335769 A1
(43) Pub. Date: Nov. 22, 2018

(54) SYSTEM AND METHOD FOR MANUFACTURING DATA CAPTURE AND MESSAGING

(71) Applicant: Micro Automation Industries, Dubai (AE)

(72) Inventor: Hazim Al-Hajjaj, Dubai (AE)

(21) Appl. No.: 16/049,995

(22) Filed: Jul. 31, 2018

Related U.S. Application Data
(62) Division of application No. 14/954,621, filed on Nov. 30, 2015.
(60) Provisional application No. 62/085,724, filed on Dec. 1, 2014.

(51) Int. Cl. G05B 19/418; G06Q 10/06; G06Q 10/08; G06Q 50/04

(52) U.S. Cl. CPC G05B 19/4188; G06Q 10/0631; G06Q 10/0833; G05B 2219/32191; Y02P 90/22; Y02P 90/30; Y02P 90/18; G06Q 50/04

(57) ABSTRACT

A system for manufacturing data capture and messaging is disclosed In an embodiment, the system comprises: a master facility control subsystem in communication with at least one production facility; a plurality of station units in communication with the master facility control subsystem, each of the station units comprising, one or more data collection devices configurable to collect data from work pieces and data entered by a worker at the station; and a station node comprising a controller configurable to receive station data from the one or more data collection devices, wherein the station node is further configurable to transmit the station data to the master control facility subsystem for processing and storage.

### RELATED APPLICATIONS

This application is a division of U.S. patent application Ser. No. 14/954,621, file Nov. 30, 2015. U.S. patent application Ser. No. 14/954,621 claims the benefit of U.S. Provisional Patent Application No. 62/085,724, filed Dec. 1, 2015. Both prior applications are incorporated by reference herein in their entirety.

### FIELD OF THE INVENTION

Inventions disclosed and claimed herein are in the field of computer assisted management of manufacturing processes.

### BACKGROUND

A production line is a set of sequential operations established on a factory shop floor whereby materials are put through a refining process to produce an end product that is suitable for onward consumption, or components are assembled to make finished goods. In general, a production process involves a moving platform or conveyor to move partially completed products to workers who perform simple repetitive tasks designed to permit very high rates of production per worker.

A traditional, manual information system cannot meet the requirements of a fast response environment. Such a system depends on other supplementary devices to facilitate automation of data transactions. Manual tracking of production activities and manual entry of data is very problematic. For example, manual tracking invites inaccurate reporting due to human error, delayed cost reporting, slowed decision making, and faulty decision making sue to inaccuracies in initial reports.

Motivation of workers is becoming more and more of a concern in all types of employment environments. Providing timely and specific information to workers about their own productivity and that of their coworkers empowers workers to understand their objectively measured performance and how to improve it.

### BRIEF DESCRIPTION OF THE DRAWINGS

FIG. 1 is a block diagram of a system for manufacturing data capture and messaging according to an embodiment.

FIG. 2 is a block diagram of a system for manufacturing data capture and messaging according to an embodiment.

FIG. 3A is an illustration of a worker database graphical user interface (GUI) according to an embodiment.

FIG. 3B is an illustration of a task database graphical user interface (GUI) according to an embodiment.

FIG. 4 is a schematic representation of a production plan according to an embodiment.

FIG. 5 is an illustration of an event database graphical user interface (GUI) according to an embodiment.

FIG. 6 is a block diagram of a system for manufacturing data capture and messaging according to an embodiment.

FIG. 7 is an illustration of a node and bar code reader according to an embodiment.

FIG. 8 illustrates a logic diagram representing input/output and data flow of the system according to an embodiment.

FIG. 9 illustrates manufacturing station information as displayed according to an embodiment.

### DETAILED DESCRIPTION

Embodiments disclosed herein include a real-time production line data collection system that collects and makes available current data regarding production line statistics and environmental factors, as well as statistical data relating to specific workers. The data is made available to chosen parties (such as supervisors and owners). In addition, an individual's worker data is made available to that worker. The system can also provide information to all workers regarding comparative performance statistics so that each worker knows at any time how their production and accuracy are measured compared to others. This allows each worker to know his downtime, quantity produced per unit time, quantity expected to be produced, etc. A worker can also be specifically messaged to inform of negative statistical trends, to allow for immediate correction.

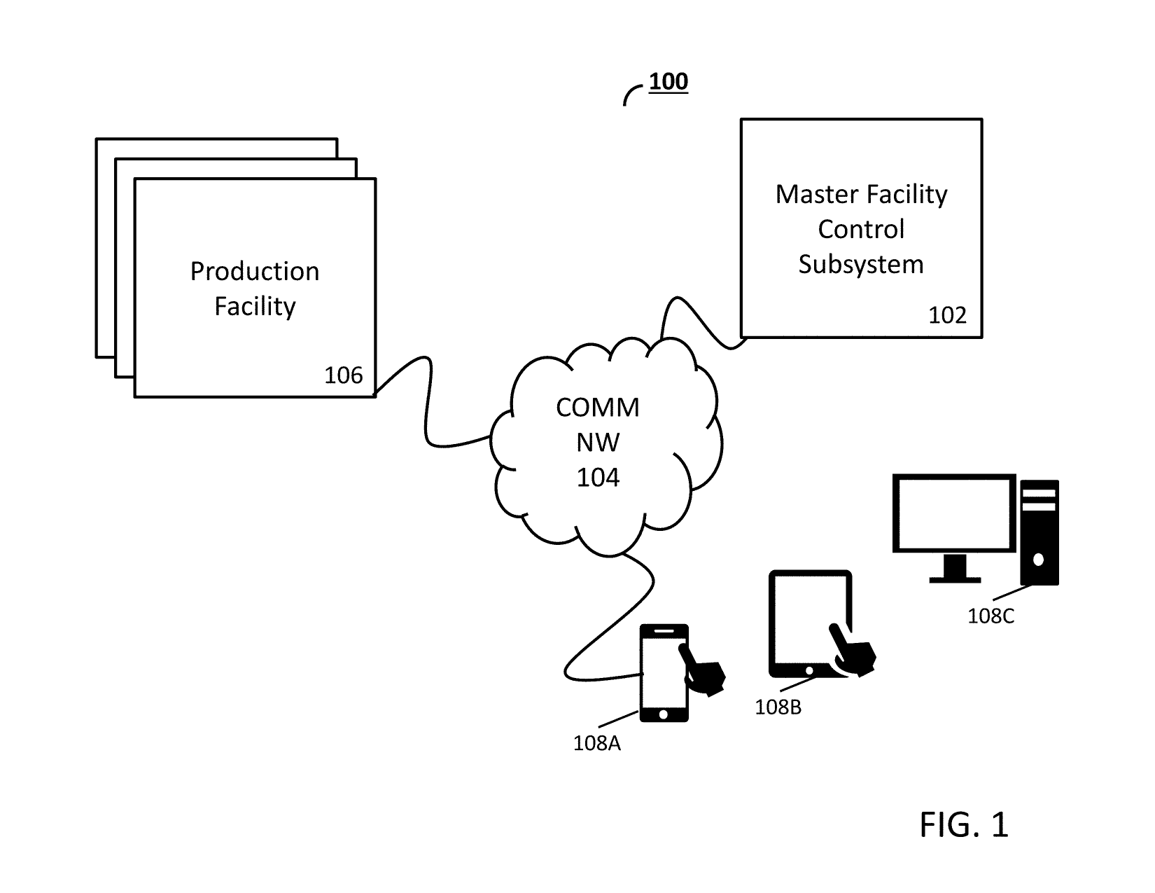

FIG. 1 is a block diagram of a manufacturing data capture and messaging system 100 according to an embodiment. The system 100 includes a master facility control subsystem 102 as further described below. The control subsystem 102 communicates via communication network 104 with one or many production facilities 106. Production facilities 106 can be any sort of production process, whether located in one geographic location, or distributed geographically. Communication network 104 can be any communication network, including but not limited to the Internet, local area networks (LANs), wide area networks (WANs), etc. A variety of user devices 108 also communicate with the subsystem 102 via the network 104. These include, but are not limited to mobile phone 108A, personal computer 108B, and tablet computing device 108C. The master facility control subsystem 102 is shown as a discrete entity with a display and a server including at least one processor. However, in various embodiments the master control subsystem 102 is distributed across a network, including distributed data storage, distributed processors, and shared processing functionality across multiple distributed processors.

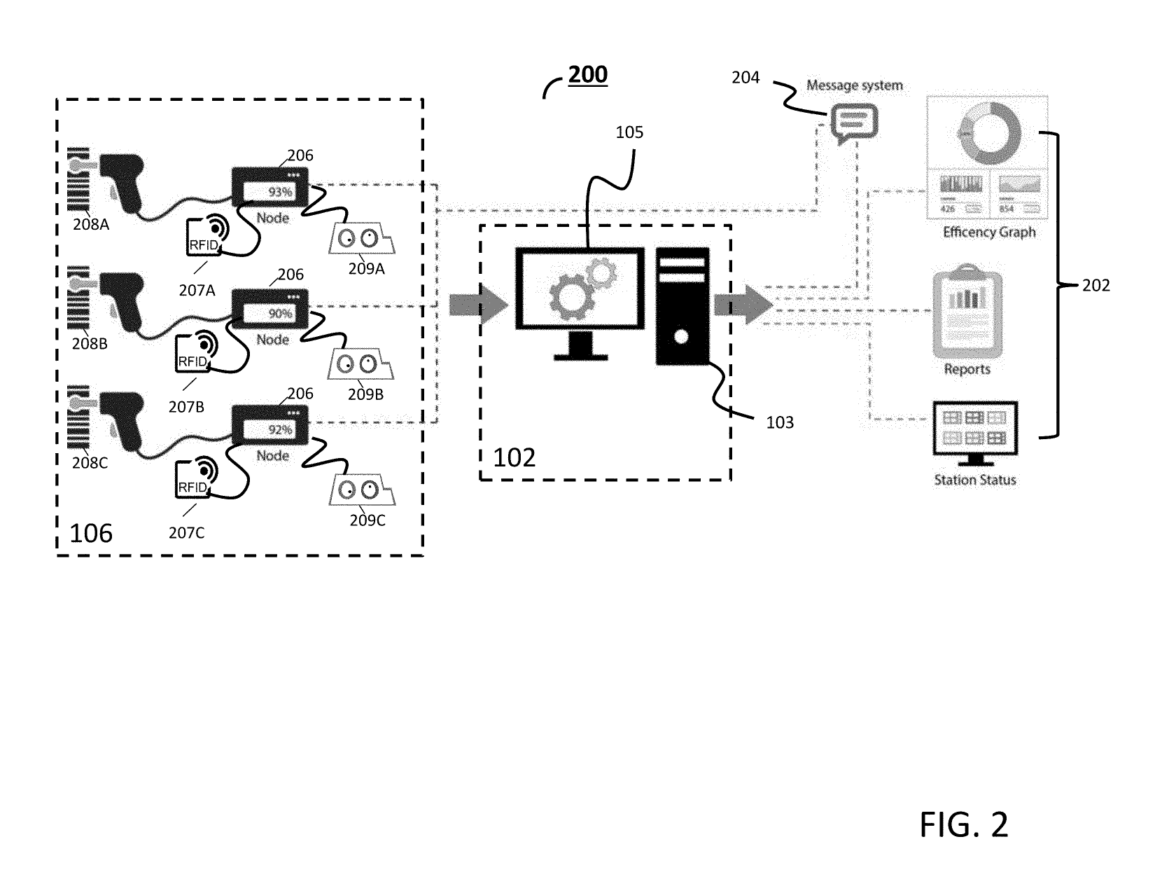

FIG. 2 is a block diagram of a system 200 according to an embodiment.

Master facility control subsystem 102 includes a display 105 and a server 103. The susbsystem 102 receives data via the network 104 from different stations on an example assembly line in a production facility 106. For example, bar codes scanner 208A-208C scan barcodes to transfer data to nodes 206A-206C at stations A-C. As described below, barcodes are typically attached to workpiece items handled by a worker in the production process.

Each node 206 is further coupled to a radio frequency identification (RFID) sensor pad 207 and sensor interface 209. In some embodiments, the RFID sensor pad reads RFID tags placed on work in progress (WIP) subassemblies.

The bar code scanner 208, the RFID sensor pad 207 and the sensor interface 209 can also communicate wirelessy with the node 206 using any know wireless communication standard, such as WiFi or Bluetooth. Similarly, stage nodes 206 can communicate wirelessy with the master facility control subsystem 102.

The subsystem 102 outputs data as various reports available through graphical user interfaces (GUIs) 202, as further described below. A messaging system 204 also receives output data from the subsystem 102 and forms and transmits appropriate messages to the production facility 106 through the display in the node.

On the example production assemble line, different stages are defined for producing one product, and for each stage there are number of components to be assembled together. A stage code and a barcode are assigned for stages and components, and these data are stored in a product setting database (in an embodiment, this is includes Excel based setting files in .csv format). Also, a standard time for finishing one stage is defined.

The system 200 allows workers, machines, and material to communicate online through the subsystem 102. This is achieved as follows: worker is recognized by the station through his/her ID and hence the worker name, and to which process he/she have been trained, the machine status is recognized through sensor interface of the node 206, the work in progress (WIP) material is identified through its code, which also indicates which product the material belongs to and which manufacturing process stages have been completed on that WIP material. Using this information, the system 100 configures the process that should be done for that WIP material. In addition the system determines whether the worker sitting in the station is trained to do that job, whether the machine at that station can do that process, and whether the parts required for that process have a stock at that station. The subsystem 102 captures the information/data from the assembly line through the node 206. It sends a message to the node 206 display stating what process should be performed. This enable the subsystem 102 to assign the process to the station in which a worker sitting at that station is qualified for that process The machine is also recognized as suitable for that process, and it is determined whether there is stock of parts (raw material) in that station. The subsystem 102 configures which process should be done at a certain moment for a certain stage, to a certain WIP material, by a worker sitting in that station, and assures that the machine in that station is ready to do that process.

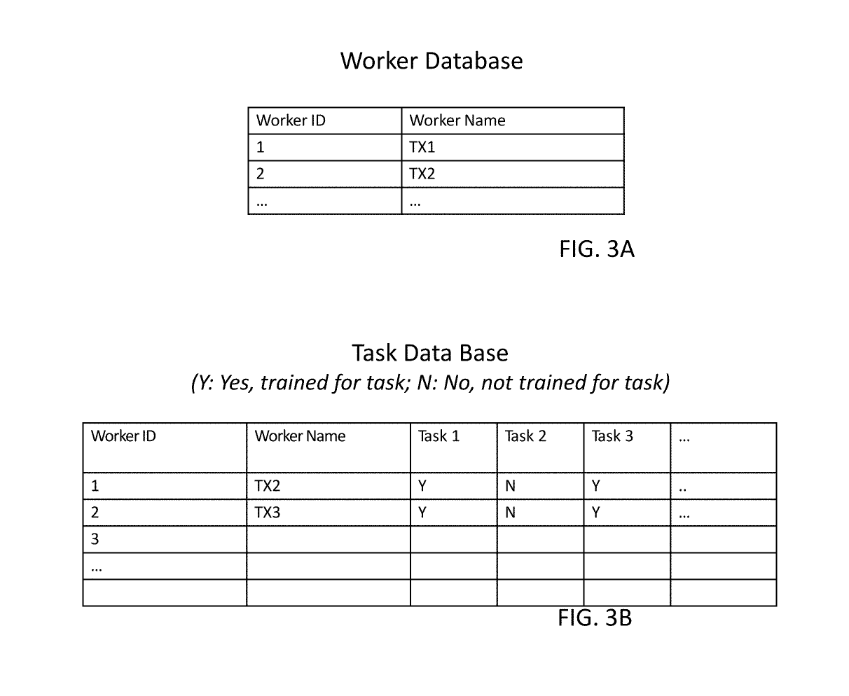

For each worker on the assembly line, he or she is assigned one worker ID, and each worker ID is linked to certain tasks that the worker was trained for. This information is stored in a worker database and a task database, as shown in FIGS. 3A and 3B. The worker database of FIG. 3A lists worker IDs and worker names associated with the IDs. The task database lists worker IDs, worker names, and the tasks for which each worker is trained. The ID stick can be a microcontroller with internal processor, or low power Bluetooth.

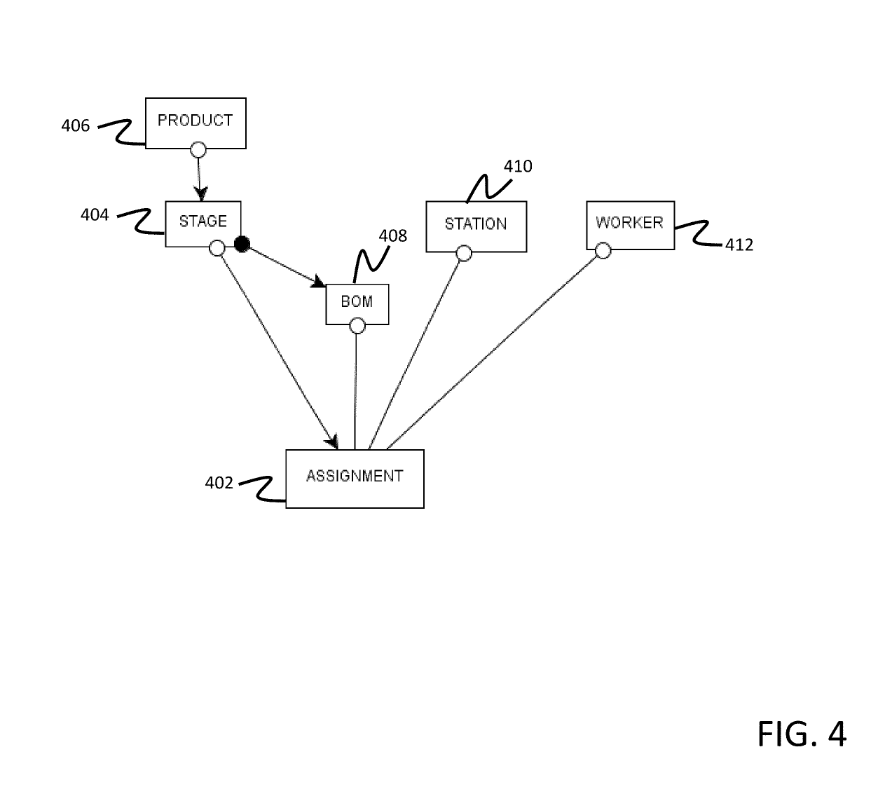

A production supervisor may construct a production plan which assigns stages of production to different production stations and workers. Each worker's ID is assigned to a stage of a product for which he or she is trained. FIG. 4 is a diagram illustrating a production plan. For each product 406, there are n stages 404. For each stage, there is a corresponding bill of materials (BOM) 408. For each assignment 402, one worker 412 is assigned to one station 410. To begin working, the worker inserts an ID stick to the appointed station, as long as the ID stick is inserted the time counting for producing starts, and this event is stored with a time stamp in the event database under attributes DATE_TIME, UNIT_CODE, WORKER_ID (other attributes are stored as defined in the programming code).

When a worker sits in any station, the subsystem 102 will assign the WIP material to come in front of him/her as far he/she is trained to do the process required for that WIP material, and as far as the machine at that station is ready to perform the process. The worker will automatically know what process to do, through the display at the node; which parts to attach to perform the assigned process and, to make the WIP material ready for the next stage. Once the process is completed, the WIP material is directed to another station performing the next process to another worker suitable to do that process. This continues until the product reaches a final stage. In an embodiment, the subsystem 102 calculates the worker's efficiency and productivity, to assign the process to the most efficient worker. This makes the production more flexible and enables production of diverse products at the same time,

Using identification tools such as RFID and barcode readers, WIPs in the production line are tracked throughout the production process and the data is captured by subsystem 102. One objective is to assign processes to each active station, thus eliminating the need to pre-assign the station for performing certain process. That is, and independent decision can be taken within the work flow in real-time to allow greater product diversity, facilitate shorter delivery time, eliminate the need for batch production arrangement, and make the most efficient use of production space.

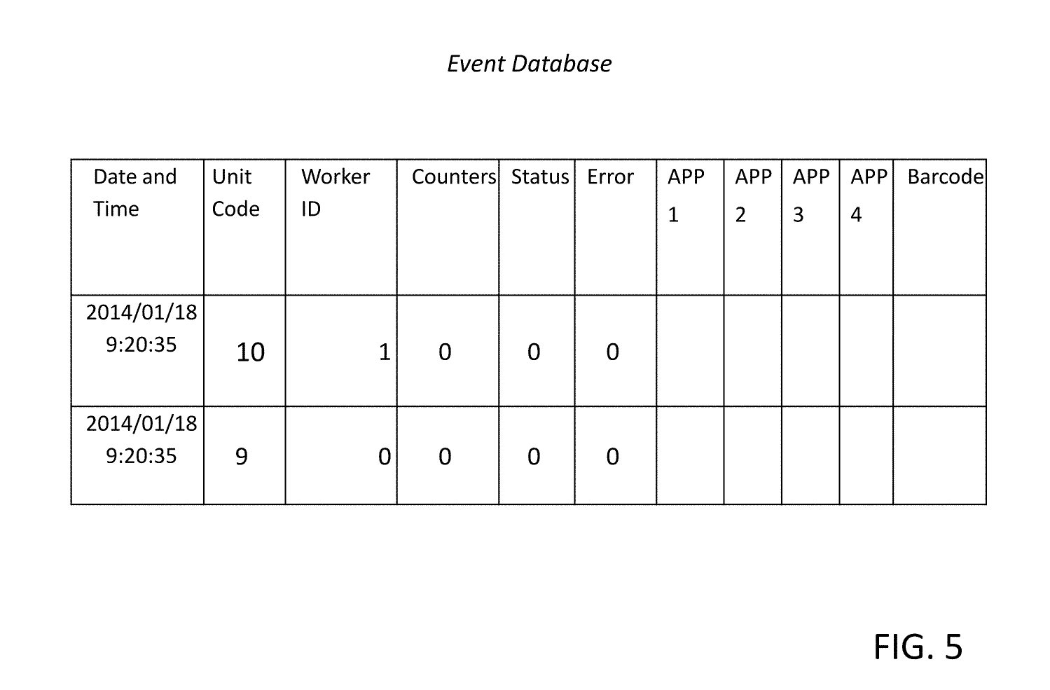

FIG. 5 is a diagram of event database entries. When one ID was inserted in the event database, the worker's ID will fill in the cell instead of storing 0.

When the worker completes an item for the particular stage at the assigned station, the worker scans a barcode on the item by using the barcode scanner on the station, and then passes the item to the next station, a scanned time stamp is stored in the event database under attributes DATE_TIME, UNIT_CODE, WORKER_ID, BARCODE (other attributes are stored as defined in the programming code). The difference of the first timestamp and the second time stamp of certain worker is the producing time for the first item. The time difference of the second scanned time stamp and the third scanned time stamp is the producing time of the second item, and so on. When there is no barcode on the item, the worker can press the button on the station and this event is stored in the event database under attributes DATE_TIME, UNIT_CODE, WORKER_ID, and COUNTER (other attributes are stored as defined in the programming code).

When the worker steps away from the station for any reason, he/she should remove ID stick from the station. The subsystem 102 recognizes this and store the event in the event database under attributes DATE_TIME, UNIT_CODE, and WORKER_ID (other attributes are stored as defined in the programming code). The WORKER_ID is filled by 0 if there is no ID inserted in the station. Once the worker returns to the station and reinserts the ID stick in the station, the system recognizes the event and store it in the event database under attributes DATE_TIME, UNIT_CODE, and WORKER_ID (other attributes are stored as defined in the programming code).

A similar operation standard as applied to assembly operations is also applied to raw material preparation and packaging stages. In some time, due to the arrangement of production 1 worker may work on 2 sequential stages or non-sequential stages. For 2 sequential stages, worker can do scanning after finishing 2 stages, and for non-sequential stages worker should scan after each stage.

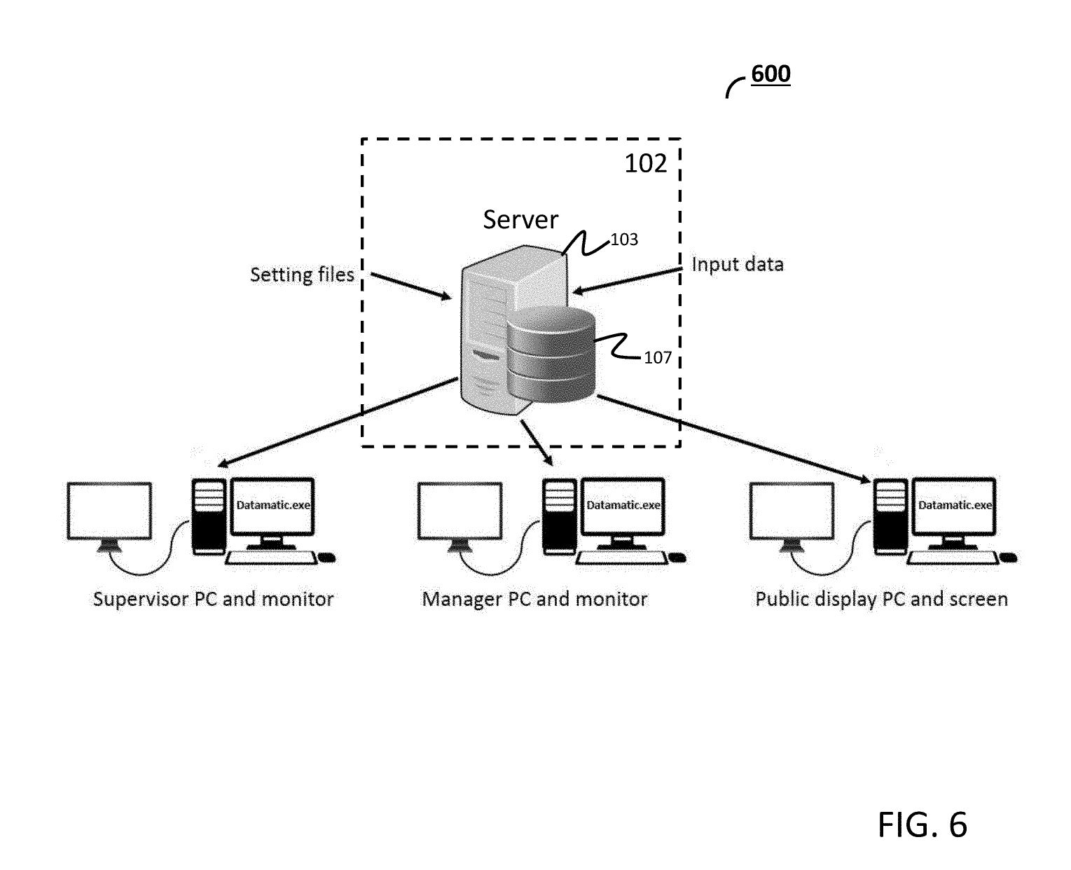

FIG. 6 is a block diagram of a system 600 according to an embodiment. Subsystem 102 includes hardware and software. System execution files may be installed on different PCs or laptops, and these devices connect to a server 103 which contains setting files and input data, e.g. event data, worker data, production data. The server 103 receives data from production stations and sends data to different PCs (such as supervisor PC, manager PC and public display PV. The system execution files further analyze the data and present the results. Subsystem 102 also stores current and historical data on databases 107 As previously described, the server 103, in other embodiments, is distributed and communicates with various supervisor, manager or public display devices (such as devices 108) via the Internet, and in some cases wirelessly.

The public display PC is typically a very large screen suitable to be placed in a public area so that all workers in a production area can view current production data. This data can be predetermined to show, for example, performance of the group as a whole, performance of top workers at any one time, stations that are more efficient, stations that are less efficient, etc. This provides motivation for workers to compete with each other and with themselves to increase productivity.

In the example illustrated, one master node (PC) connects to several slave nodes (stations), and these slave nodes are equipped with screen unit, barcode scanner, ID stick and interface, and switch. The node contains an electronic unit and shares a common serial communication bus (e.g. RS-485 bus) with the master node.

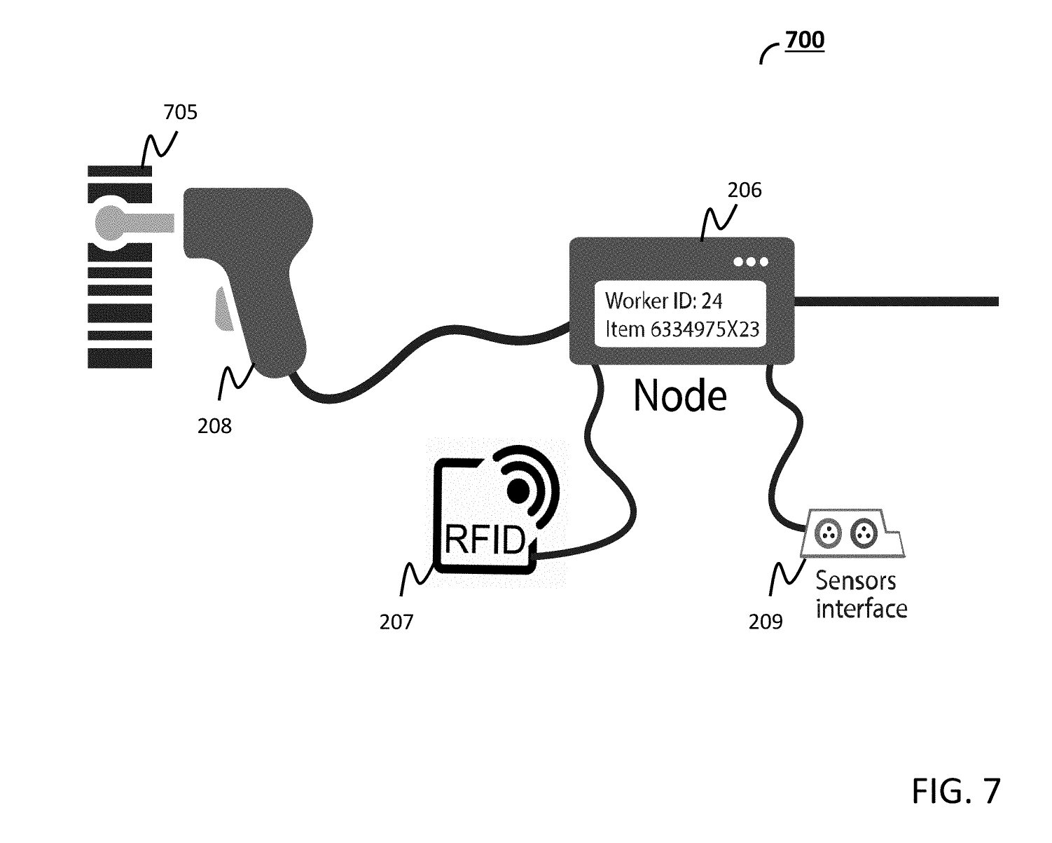

FIG. 7 is a diagram of a station unit 700 according to an embodiment. Station unit 700 is an example of what each station is supplied with, a station node switch (also referred to as node or slave node) 206. The node 206 includes a controller that facilitates collection of station data communication between the station node and the master facility control subsystem 102 (as a slave master node), and communication between station nodes. In an embodiment, a programmable peripheral interface controller (PIC) in the slave node 206 facilitates communication between slave nodes and master nodes. Typically worker ID stick is a USB flash drive device, but embodiments are not so limited. In other embodiments, a radio frequency identification (RFID) tag may be attached to the workers clothing or badge and be read by and RFID reader at the station. The node 206 is further in communication with one or more data capturing devices. Data capturing devices include an RFID sensor pad 207 and a sensor interface 209. The node 207 can be connected to the RFID sensor pad 207 and sensor interface 209 for wired communication, or can just as easily be configured for wireless communication with RFID sensor pad 207 and sensor interface 209. Data capturing devices can also include a bar code scanner 208 for scanning a bar code 705. Sensor interface 209 capture data from the machine (not shown) at that station through auxiliary contact, serial interface (RS484, RS232, etc.).

The node 206 receives station data from the data collection device(s) and transmits the data to the master facility control subsystem 102. Station data includes, but is not limited to: time a worker begins and stops working; ID information for all work pieces or subassemblies; time to complete the task intended to be completed at the station; number of task completions/time period. Node 206 further includes a display (as shown) that allows the worker to see any station data, pre-selected by a production manager, and messaging data (as further described below). In some embodiments, node 206 receives station data input directly by a worker at the station, for example through a keyboard or other user interface device (not shown). In some embodiments, node 206 includes a USB port for receiving a USB drive containing worker data or station data.

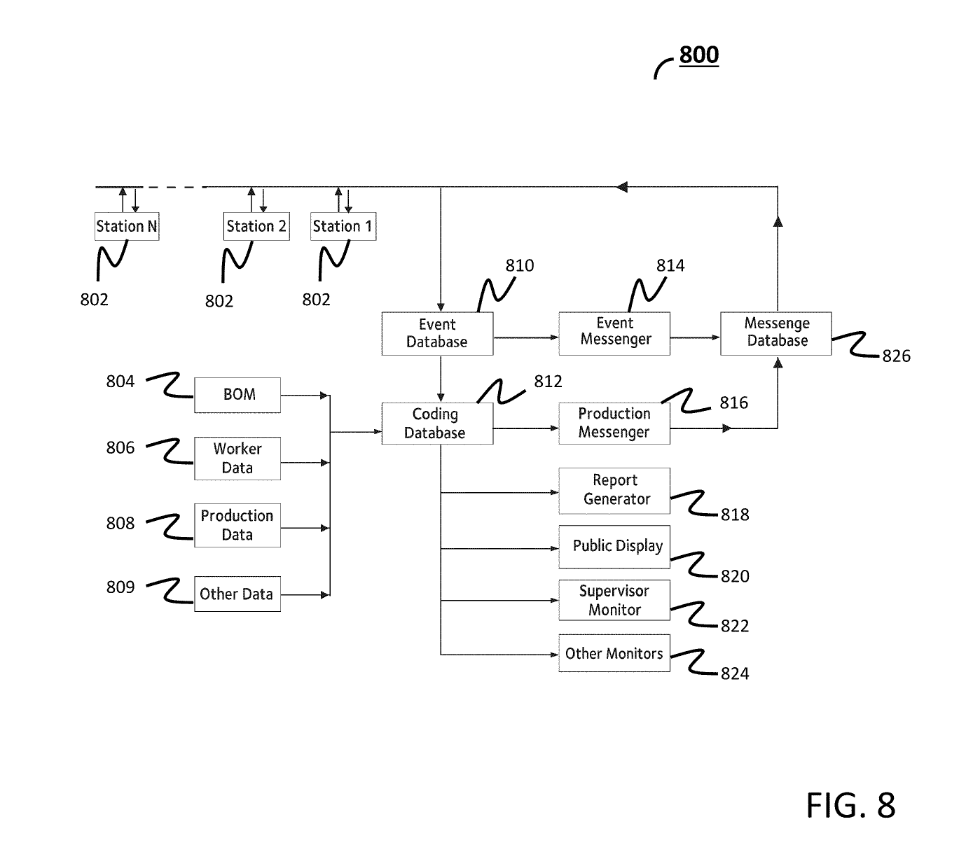

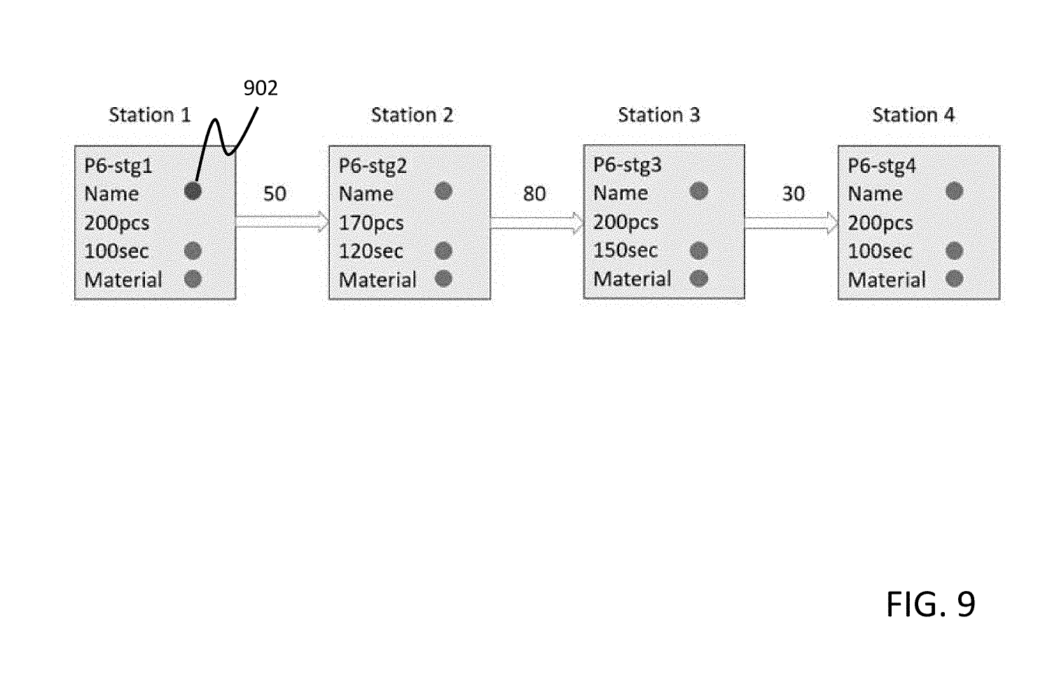

FIG. 8 is a block diagram of a logic structure 800 based on a business description of an example assembly line production. This logic structure is useful for software development and for obtaining an overview of data flow in the system. The subsystem software reads data from the event database, and can combines different input data, and perform data analysis.

Slave nodes at a station 802 capture data. There are multiple stations 802(1) through 802(N). An event database 810 stores events. For example, the event “worker inserts her ID stick” is stored into the event database 810 with a predetermined format. An event messaging 814 generates messages, such as auto feedback of the content of the barcode scanned to the nodes and the content from the ID stick.

An example event message:
Default message: PLDC ready.
ID stick feedback message: e.g. worker ID=10 and worker ID=0.
Barcode feedback message: ADZNV12W242I1234Q123

A message database 826 stores all messages from the event messaging 814, and from a production messaging 816. These messages are sent one by one to the corresponding nodes. A coding database 812 stores the relevant software code for performing the management methods described herein, including for example VB code and Java code, logic code, computing code, and so on. The production messaging 816 generates production parameters in a pre-defined format, and sends then as a message to the message database 826. Some or all of a production message can be sent as desired to one or more productions stations. In an embodiment, the production message is displayed on a node such as node 702.

An example production message:
1^{st} row: barcode of the scanned panel
2^{nd} row: E:??%Q:???T:???sec
T: Time consumed for last piece (in sec)
Q: accumulated Quantity produced numerical)
E: Efficiency (in percentage)

The production message may also include an encouragement or prompting message as a text field which is part of a station status monitor and is sent to appropriate stations.

A bill of materials (BOM) 804 includes related components and quantities for producing a certain stage of a certain product. The item finished in a previous stage is a BOM item of a next stage. Worker data 806 includes worker ID, name, and qualified tasks. Production data 808 includes stages of certain products, standard producing time for certain stages, and maximum and minimum producing time tolerances. Other data 809 can include order information, components warehouse stock information and so on. A report generator 818 generates a production report, e.g. a daily production report. A public display 820 is a monitor for presenting output of the subsystem via a GUI. For example, public display 820 can be a large monitor located into the workshop so as to be visible to all workers in the workshop. A supervisor monitor 822 is a separate monitor for displaying output on a dedicated device such as a supervisor's PC or tablet. Various other monitors 824 can exist for displaying selected subsystem output.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. A computer-implemented method for controlling at least one production facility, the method comprising:
a station node receiving station data from at least one data collection device;
the station node transmitting the station data to a master facility control subsystem;
the master facility control subsystem processing and storing the station data, and generating a plurality of reports; and
the master facility control subsystem sending messages to the station node, including messages related to current production performance at the station node.

2. The method of claim 1, further comprising the master facility control subsystem displaying a public message to all workers in a production area so as to display performance data for motivational purposes.

3. The method of claim 1, wherein the at least one data collection device comprises:
a USB port; and
an RFID sensor.

4. The method of claim 1, further comprising the master facility control subsystem maintaining a plurality of databases, comprising a worker database, a task database, and an event database.

5. The method of claim 1, wherein the station data comprises:
time a worker begins and stops working;
ID information for all work pieces and subassemblies;
time to complete a task intended to be completed at a station; and
number of task completions/time period at a station.

6. A non-transient computer readable medium having instruction stored thereon, that when executed by a master facility control subsystem processor cause the execution of a production facility control method, the method comprising:
a station node receiving station data from at least one data collection device;
the station node transmitting the station data to the master facility control subsystem;
the master facility control subsystem processing and storing the station data, and generating a plurality of reports; and
the master facility control subsystem sending messages to the station node, including messages related to current production performance at the station node.

7. The method of claim 6, further comprising the master facility control subsystem displaying a public message to all workers in a production area so as to display performance data for motivational purposes.

8. The method of claim 6, wherein the station data comprises:
time a worker begins and stops working;
ID information for all work pieces and subassemblies;
time to complete a task intended to be completed at a station; and
number of task completions/time period at a station.

9. The method of claim 6, further comprising:
the master facility control subsystem recognizing a worker at a station through a worker ID;
the master facility control subsystem determining processes for which the worker is trained;
the master facility control subsystem recognizing a machine status at the station;
the master facility control subsystem identifying work in progress (WIP) material as being associated with a particular produce; and
the master facility control subsystem identifying which manufacturing process stages have been completed on that WIP material.

10. The method of claim 6, further comprising:
the master facility control subsystem displaying a message on a station node display relating to a process to be performed;
the master facility control subsystem assigning WIP material to come in front of a worker at the station to the extent the worker is trained to perform required processes; and
the master facility control subsystem directing the WIP material to a next station when the worker completes one or more processes at the station.
